(19) United States
(12) Patent Application Publication
(10) Pub. No.: US 2026/0178284 A1
(43) Pub. Date: Jun. 25, 2026

(54) Multi Agent System for User Interface Builder Operations

(71) Applicant: ServiceNow, Inc., Santa Clara, CA (US)

(72) Inventor: Sai Vishwak Korimerla, Hyderabad (IN)

(21) Appl. No.: 18/987,352

(22) Filed: Dec. 19, 2024

(51) Int. Cl. G06F 8/35

(52) U.S. Cl. CPC G06F 8/35

(57) ABSTRACT

A method includes obtaining a prompt characterizing a software development task. The method includes determining, using an initial large language model (LLM), a type of the software development task based on the prompt. Based on the type of the software development task, the method includes selecting one or more of a plurality of operation LLM agents. Each respective operation LLM agent is conditioned to generate corresponding software code for a respective type of software development task. Using the selected one or more of the plurality of operation LLM agents, the method includes generating software code based on the prompt. The method includes performing the software development task based on the generated software code.

### TECHNICAL FIELD

This disclosure relates to code generation.

### BACKGROUND

Software development is the process of creating software programs that perform specific tasks or provide certain functions for users, such as web browsers, games, business applications, or mobile applications. Application developers need to understand various programming languages, tools, frameworks, and methodologies to create applications. Some software development platforms offer low-code or no-code environments that enable software creation and modification using graphical interfaces, drag-and-drop components, pre-built templates, and other tools. However, even in these low-code or no-code environments, users must possess a basic knowledge of software development to use the drag-and-drop components and pre-built templates effectively. Therefore, these environments are not suitable for users who lack any coding experience.

### SUMMARY

One implementation of the disclosure provides a computer-implemented method of generating software code using a multi-agent code generator. The method includes obtaining a prompt characterizing a software development task. Using an initial large language model (LLM) agent, the method includes determining a type of the software development task based on the prompt. The method includes selecting one or more of a plurality of operation LLM agents based on the type of the software development task. Each respective operation LLM agent is conditioned to generate corresponding software code for a respective type of software development task. Using the selected one or more of the plurality of operation LLM agents, the method includes generating software code based on the prompt. The method includes performing the software development task based on the generated software code.

Implementations of the disclosure may include one or more of the following optional features. In some implementations, the method further includes, for each respective operation LLM agent, obtaining a respective conditioning prompt specifying natural language instructions that guide the respective operation LLM agent to generate the corresponding software code for the respective type of the software development task and conditioning the respective operation LLM agent on the respective conditioning prompt. In these implementations, each respective operation LLM agent may be conditioned on the respective conditioning prompt before receiving the prompt. Each respective operation LLM agent may include a multimodal LLM configured to process text and image inputs.

In some examples, the prompt includes a natural language command characterizing the software development task. In these examples, the natural language command may include a textual input or a spoken input. In some implementations, the prompt includes a snapshot image of an example software application to be replicated. Here, the snapshot image may include markup text indicating one or more modifications to perform on the example software application. The markup text may include computer generated text. The markup text may include human written text. In some examples, the method further includes quantizing each operation LLM agent of the plurality of operation LLM agents.

The method may further include receiving a query specifying the software development task and generating, using a tool LLM agent, one or more example prompts for the software development task based on the query. In some implementations, each respective operation LLM agent of the plurality of operation LLM agents includes the same underlying LLM model. In other implementations, at least one operation LLM agent of the plurality of operation LLM agents includes a different underlying LLM model than the other operation LLM agents of the plurality of operation LLM agents. Performing the software development task may include building a software application. In some examples, the method further includes generating a first portion of the software code based on the prompt using a first operation LLM agent of the plurality of operation LLM agents and generating a second portion of the software code based on the prompt using a second operation LLM agent of the plurality of operations LLM agents. Here, generating the software code is further based on the first

Another implementation of the disclosure provides a system that includes data processing hardware and memory hardware storing instructions that when executed on the data processing hardware causes the data processing hardware to perform operations. The operations include obtaining a prompt characterizing a software development task. Using an initial large language model (LLM) agent, the operations include determining a type of the software development task based on the prompt. The operations include selecting one or more of a plurality of operation LLM agents based on the type of the software development task. Each respective operation LLM agent is conditioned to generate corresponding software code for a respective type of software development task. Using the selected one or more of the plurality of operation LLM agents, the operations include generating software code based on the prompt. The operations include performing the software development task based on the generated software code.

Implementations of the disclosure may include one or more of the following optional features. In some implementations, the operations further include, for each respective operation LLM agent, obtaining a respective conditioning prompt specifying natural language instructions that guide the respective operation LLM agent to generate the corresponding software code for the respective type of the software development task and conditioning the respective operation LLM agent on the respective conditioning prompt. In some examples, the operations further include generating a first portion of the software code based on the prompt using a first operation LLM agent of the plurality of operation LLM agents and generating a second portion of the software code based on the prompt using a second operation LLM agent of the plurality of operations LLM agents. In these examples, generating the software code is further based on the first portion of the software code and the second portion of the software code.

Another implementation of the disclosure provides a computer-readable medium having instructions that, when executed by data processing hardware, causes the data processing hardware to perform operations. The operations include obtaining a prompt characterizing a software development task. Using an initial large language model (LLM) agent, the operations include determining a type of the software development task based on the prompt. The operations include selecting one or more of a plurality of operation LLM agents based on the type of the software development task. Each respective operation LLM agent is conditioned to generate corresponding software code for a respective type of software development task. Using the selected one or more of the plurality of operation LLM agents, the operations include generating software code based on the prompt. The operations include performing the software development task based on the generated software code.

The details of one or more implementations of the disclosure are set forth in the accompanying drawings and the description below. Other implementations, features, and advantages will be apparent from the description and drawings, and from the claims.

### DESCRIPTION OF DRAWINGS

FIG. 1 is a schematic view of an example system executing a multi-agent code generator.

FIG. 2A is an illustrative view of an example snapshot image of a prompt.

FIG. 2B is an illustrative view of an example application interface generated from the example snapshot image of FIG. 2A.

FIG. 3 is a schematic view of an example graphical user interface of the multi-agent code generator.

FIG. 4 is a flowchart of an example arrangement of operations for a computer-implemented method for generating software code using a multi-agent code generator.

FIG. 5 is a schematic view of an example computing device that may be used to implement the systems and methods described herein.

Like reference symbols in the various drawings indicate like elements.

### DETAILED DESCRIPTION

Low-code or no-code environments are designed to enable individuals with little to no programming experience to create fully functional applications. As such, these environments lower the barrier to entry for application development, allowing a broader range of users, including business analysts, project managers, and other non-technical stakeholders, to participate in the creation and customization of software solutions. Functionally, low-code or no-code platforms generally provide a user-friendly interface, often featuring drag-and-drop components, pre-built templates, and visual workflow builders. These tools allow users to design user interfaces, define business logic, and manage data without writing any code. However, even in these low-code or no-code environments, users must possess a basic knowledge of software development to use the drag-and-drop components and pre-built templates effectively. For instance, a user is still required to understand which components are compatible to be connected with the drag-and-drop feature. Thus, conventional low-code and no-code environments may not be effective for users with little to no coding experience.

Accordingly, implementations herein are directed toward a multi-agent code generator for building software applications. The multi-agent code generator receives a prompt characterizing a software development task and determines, based on the prompt, a type of the software development task using an initial large language model (LLM) agent. The multi-agent code generator selects one or more of a plurality of operation LLM agents based on the type of the software development task. Each respective operation LLM agent is conditioned to generate corresponding software code for a respective type of software development task. The multi-agent code generator generates software code based on the prompt using the selected one or more of the plurality of operation LLM agents and performs the software development action based on the generated software code. That is, the multi-agent code generator may execute the generated software code to perform the software development action.

Advantageously, the multi-agent code generator not only simplifies the application development process for non-developers but also abstracts the underlying complexities of various software development operations. By enabling users to describe their desired application with image inputs, natural language commands, or any combination thereof, the multi-agent system generates the corresponding steps required to construct the application. This allows users with little to no coding or application development experience to successfully build and launch applications. Additionally, the multi-agent code generator addresses the computational challenges associated with running large LLM models by optionally employing smaller, quantized models that can fit into RAM and execute within a WebAssembly (WASM) runtime. This approach leverages the native support for WASM in modern browsers, thereby mitigating issues related to compute cost and latency, and enabling efficient problem-solving directly within the browser environment.

Moreover, each respective operation LLM agent may be conditioned on a respective conditioning prompt before receiving or processing the prompt. Conditioning the operation LLM agents before receiving the prompt reduces the latency when processing the query to generate software code. Each respective conditioning prompt specifies natural language instructions that guide the respective operation LLM agent to generate the corresponding software code for the respective type of the software development task. Accordingly, the operation LLM agents that generate the software code are specialized to generate software code particularly for that specific type of software development task. In contrast, a naïve approach to this problem would be to use a single operation LLM agent with a single conditioning prompt that guides the single operation LLM to perform all types of tasks. Yet, the length of the conditioning prompt required to guide the operation LLM agent to perform all types of tasks may exceed input token limits of the operation LLM agent or obscure some of the instructions due to the excess length of the conditioning prompt. As such, by splitting up the conditioning prompt over multiple operation LLM agents, the multi-agent code generator avoids input token limit issues and tailors each operation LLM agent particularly on a specialized task.

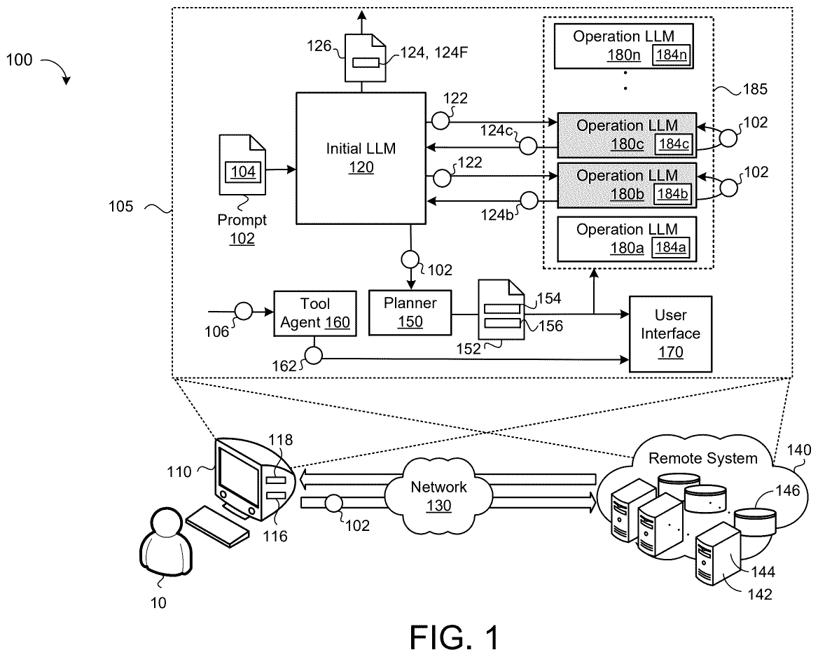

Referring to FIG. 1, in some implementations, a system 100 includes a remote system 140 in communication with one or more user device 110 each associated with a respective user 10 via a network 130, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 is configured to communicate with the user device 110 via the network 130. The user device 110 may correspond to any computing device, such as a desktop workstation, a laptop workstation, or a mobile device (i.e., a smart phone). Each user device 110 includes computing resources 116 (e.g., data processing hardware) and/or storage resources 118 (e.g., memory hardware).

The remote system 140 and/or the user device 110 may execute multi-agent code generator 105. The multi-agent code generator 105 includes an initial large language model (LLM) 120, a plurality of operation LLM agents 180, 180a-n, and a selector agent 185. The initial LLM 120 is configured to obtain a prompt 102 that characterizes a software development task 104. The prompt 102 may include a natural language command that characterizes the software development task 104. The natural language command may include a textual input or a spoken input provided by the user 10 via the user device 110. For instance, the natural language command may be “create a heading component for the application.”

Moreover, the prompt 102 may include a snapshot image of an example software application 126 to be replicated. For instance, a user 10 may take a screenshot of the example software application and provide the snapshot image with the prompt 102 specifying to replicate the example application. Here, the software development task 104 is to create a software application 126 that mirrors the graphical interface appearance and functionality as shown in the snapshot image.

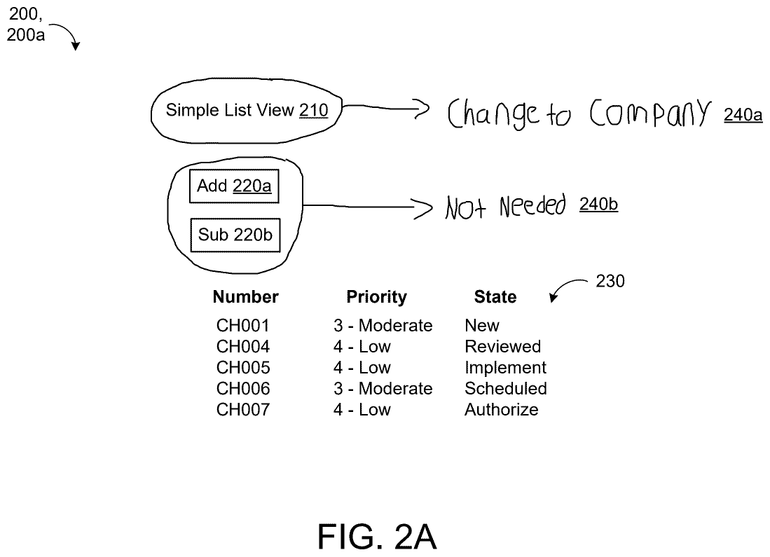

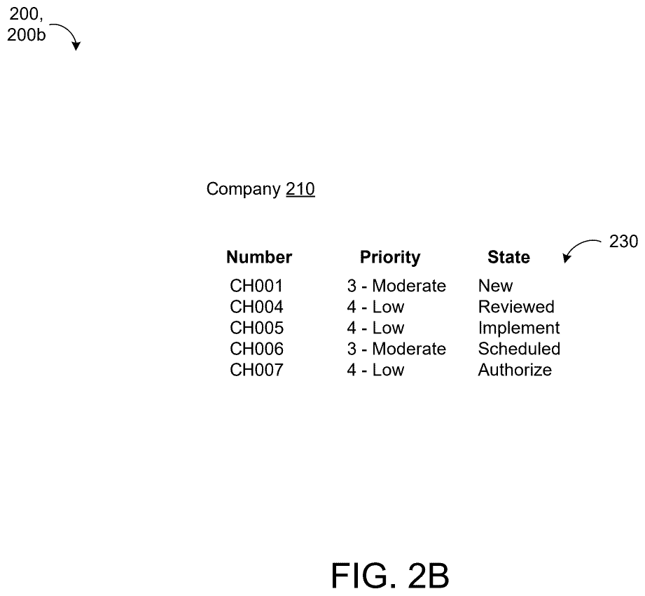

FIG. 2A depicts an example first illustrative view 200, 200a of a snapshot image of an example software application to be replicated. The example software application includes a heading component 210 labeled “Simple List View,” interactive user interface buttons 220a, 220b labeled “Add” and “Sub,” respectively, and a data table 230. The data table 230 illustrates five change request numbers each with a corresponding priority (e.g., 3-moderate or 4-low) and a corresponding state (e.g., new, reviewed, implemented, scheduled, authorize). Moreover, the snapshot image may include markup text 240 indicating one or more modifications to perform on the example software application. The markup text may include computer generated text (e.g., typeface text) and/or human written text. For instance, the prompt 102 may specify to replicate the example software application but modify one or more aspects of the example software application. For instance, in the example shown, the snapshot image includes first markup text 240a indicating to modify the heading component 210 to be labeled “Company” instead of “Simple List View.” Moreover, the snapshot image includes second markup text 240b indicating to delete the interactive user interface buttons 220a, 220b (i.e., “Not Needed”).

Referring back to FIG. 1, the software development task 104 may correspond to creating an entire application 126 or a specific portion of an application 126. For example, the software development task 104 may involve creating a heading component for the application 126, which requires software code 124 to define the heading's appearance, behavior, and integration with other components of the application 126. In another example, the software development task 104 may involve adding a data table to the application 126. The initial LLM 120 determines a type 122 of the software development task 104 based on the prompt 102. That is, the initial LLM 120 may process the prompt 102 to determine the type 122 of the software development task 104 by using natural language understanding.

The type 122 of the software development task 104 may include a wide range of software development activities. These activities may include, but are not limited to, front-end development tasks such as creating user interface components or data tables, back-end development tasks such as setting up server-side logic, database management tasks such as designing and querying databases, and integration tasks such as connecting different software modules or services. For instance, if the prompt 102 specifies “create a heading component for the application,” the type 122 would be identified as a front-end development task for creating a component.

The initial LLM 120 transmits the type 122 of the software development task 104 to the selector agent 185. The selector agent 185 is configured to select one or more of the plurality of operation LLM agents based on the type 122 of the software development task 104. Each operation LLM agent 180 is specialized in handling specific types 122 of software development tasks 104. Put another way, each respective operation LLM agent 180 is conditioned to generate corresponding software code 124 for a respective type 122 of software development task 104. To that end, the selector agent 185 may be prompted to know or maintain a list thereby indicating to the selector agent 185 which type 122 of software development task 104 each operation LLM agent 180 is specialized to handle. For instance, if the type 122 of the software development task 104 indicates creating an event trigger, the selector agent 185 may choose the respective operation LLM agent 180 that specializes in creating event triggers. In another instance, if the type 122 of the software development task 104 indicates creating a data table, the selector agent 185 may choose the operation LLM agent 180 that specializes in creating data tables.

As such, the selector agent 185 ensures that each software development task 104 is handled by the most appropriate and specialized operation LLM agent 180, thereby optimizing efficiency and accuracy in execution of the software development tasks 104. Moreover, the selector agent 185 may also consider additional parameters such as the complexity of the software development task 104, the required turnaround time, and the current workload of each operation LLM agent 180 to make an informed selection. This dynamic selection process ensures that software development tasks 104 are allocated to the most suitable LLM operation agents 180, thereby reducing processing time and improving the quality of the generated software code 124.

In some implementations, each respective operation LLM agent 180 of the plurality of operation LLM agents 180 includes the same underlying LLM model. For example, each operation LLM agent 180 may include an underlying Llama LLM model. In other implementations, at least one operation LLM agent 180 of the plurality of operation LLM agents 180 includes a different underlying LLM model than the other operation LLM agents 180 of the plurality of operation LLM agents 180. For example, one operation LLM agent 180 may include an underlying GPT LLM model while the other operation LLM agents 180 include an underlying Llama LLM model. The diversity in underlying LLM models may be advantageous in scenarios where different underlying LLM models exhibit strengths in different areas of software development tasks 104.

Regardless of whether the underlying LLM models are the same or different, each operation LLM agent 180 is conditioned to perform a specific type 122 of software development task 104. For each respective operation LLM agent 180, the multi-agent code generator 105 obtains a respective conditioning prompt 184, 184a-n specifying natural language instructions that guide the respective operation LLM agent 180 to generate the corresponding software code 124 for the respective type 122 of the software development task 104. For example, a respective operation LLM agent 180 may be conditioned to perform component type 122 software development tasks 104, for example, adding, removing, and revising user interface components for applications 126. Here, the respective conditioning prompt 184 for the respective operation LLM agent 180 may include “You are an expert UI engineering assistant with exceptional skills to perform operations such as adding, removing, and revising UI components for applications. Your job is to generate code that performs one of these operations.” In some examples, the conditioning prompt 184 sets boundaries that limit the scope of the respective operation LLM agent 180. Conditioning the respective operation LLM agent 180 guides the respective operation LLM agent 180 to be specialized and highly effective to generate software code 124 for the particular type 122 of software development task 104.

In some implementations, the conditioning prompt 184 includes one or more example software code outputs. These examples serve as single-shot or few-shot learning examples for the respective operation LLM agent 180. The multi-agent code generator 105 conditions the respective operation LLM agent 180 on the respective condition prompt 184 to guide the respective operation LLM agent 180 to process the particular type 122 of software development tasks 104. In some examples, the multi-agent code generator 105 conditions the respective operation LLM agent 180 on the respective conditioning prompt 184 before receiving or processing the prompt 102. Advantageously, by conditioning the operation LLM agent 180 before receiving or processing the prompt 102, the operation LLM agent 180 produces an output with reduced latency due to not having to process the conditioning prompt 184 with the prompt 102. In other examples, the multi-agent code generator 105 conditions the respective operation LLM agent 180 on the respective conditioning prompt 184 concurrently with processing the prompt 102. That is, the respective operation LLM agent 180 processes the prompt 102 and the respective conditioning prompt 184 in parallel. Processing in parallel refers to the respective operation LLM agent 180 performing multiple computations or operations at the same time or in an overlapping manner, rather than sequentially or one after another. Thus, processing in parallel may improve the efficiency and speed of the respective operation LLM agent 180, especially when the prompt 102 and the respective conditioning prompt 184 are complex or large.

The multi-agent code generator 105 uses the selected one or more of the plurality of operation LLM agents 180 to generate software code 124 based on the prompt 102. That is, each respective operation LLM agent 180 selected by the selector agent 185 processes the prompt 102 to generate a respective portion of the software code 124. The initial LLM 120 may receive each portion of the software code 124 and integrate the portions of the software code 124 to generate final software code 124, 124F as output. The multi-agent code generator 105 performs the software development task 104 based on the generated software code 124. That is, the multi-agent code generator 105 may execute the generated software code 124 to perform the software development task 104. Performing the software development task 104 based on the generated software code 124 includes building (e.g., deploying) the software application 126 or a portion of the software application 126 by executing the generated software code 124.

In some implementations, the selector agent 185 selects a single operation LLM agent 180 from the plurality of operation LLM agents 180 such that the single operation LLM agent 180 generates a respective portion of the software code 124 that serves as the final software code 124F. For example, the prompt 102 may specify the software development task 104 of “create a heading component labeled Company” whereby the initial LLM 120 determines the type 122 indicating that the software development task 104 is associated with a user interface component. Thus, the selector agent 185 may select the operation LLM agent 180 conditioned to generate corresponding software code 124 for user interface component type 122 software development tasks 104. Here, the selected operation LLM agent 180 processes the prompt 102 to generate the portion of the software code 124 which serves as the final software code 124F because there are no other portions of the software code 124. The selected operation LLM agent 180 may output the software code 124 directly to perform the software development task 104 or send the software code 124 to the initial LLM 120 which outputs the software code 124 to perform the software development task 104.

In other implementations, the selector agent 185 selects multiple operation LLM agents 180 from the plurality of operation LLM agents 180 such that the multiple operation LLM agents 180 collaboratively generate the software code 124. Selecting multiple operation LLM agents 180 may be particularly beneficial for complex software development tasks 104 that needs to leverage diverse expertise or multiple stages of development. For instance, a prompt 102 may specify a multi-step software development task 104, such as “create a user interface with a heading component labeled Company and a navigation bar.” In this scenario, no single operation LLM agent 180 may be specialized or conditioned to generate software code 124 for the entirety of the multi-step software development task 104.

As such, the initial LLM 120 determines that the software development task 104 includes different types 122 of software development tasks 104 and sends each type 122 to the selector agent 185. For instance, continuing with the example above, the initial LLM 120 may determine a first type 122 indicating that “create a user interface with a heading component labeled Company” from the prompt 102 indicates that the software development task 104 is associated with a user interface component and determine a second type 122 indicating the “navigation bar” indicates the software development task 104 is associated with a navigation component. To address these distinct types 122 of software development tasks 104, the selector agent 185 may select a first operation LLM agent 180 specialized in user interface design to handle the creation of the heading component labeled “Company.” Moreover, the selector agent 185 may select a second operation LLM agent 180 with expertise in navigation systems to develop the navigation bar. These multiple operation LLM agents 180 then work collaboratively, each contributing their specialized knowledge to generate the comprehensive software code 124 required for the complete user interface.

In the example shown, the selector agent 185 selects the second operation LLM agent 180b and the third operation LLM agent 180c (e.g., denoted by the greyscale shading) based on the different types 122 of software development tasks 104. In particular, the second operation LLM agent 180b may be conditioned to generate corresponding software code 124 for user interface components such that the second operation LLM agent 180b processes the prompt 102 to generate a corresponding portion of the software code 124, 124b that creates the heading component. Moreover, the third operation LLM agent 180c may be conditioned to generate corresponding software code 124 for navigation systems such that the third operation LLM agent 180c processes the prompt 102 to generate a corresponding portion of the software code 124, 124c that creates the navigation bar. In some examples, the operation LLM agents 180 may output the corresponding portions of the software code 124 directly to perform the software development task 104. In other examples, as shown in FIG. 1, the initial LLM 120 receives each corresponding portion of the software code 124 and generates the final software code 124B by integrating or synthesizing the received corresponding portions of the software code 124. In the example shown, the initial LLM 120 integrates the corresponding portions of the software code 124b, 124c to generate the final software code 124F.

As discussed above, the prompt 102 may include textual inputs, spoken (e.g., audio) inputs, and/or image inputs (e.g., snapshot images). To that end, each respective operation LLM agent 180 and the initial LLM 120 may include a multimodal LLM configured to process text, audio, and image inputs. Thus, the initial LLM 120 may receive the prompt 102 with natural language text of “replicate the example software application” as shown in this image whereby the image corresponds to the snapshot image shown in FIG. 2A. As such, the initial LLM 120 may process the natural language text and the image to determine one or more types 122 of software development task 104 from the prompt 102. The selector agent 185 selects one or more of the operation LLM agents 180 whereby the selected one or more operation LLM agents 180 generate software code 124 based on processing the prompt 102. Processing the prompt 102 may include processing the natural language text and/or the image. The multi-agent code generator 105 executes the generated software code 124 to build the example software application as shown in FIG. 2A with the modifications indicated by the markup text 240a, 240b.

As a result, FIG. 2B depicts an example second illustrative view 200, 200b of the application 126 built by executing the generated software code 124. Notably, the application 126 includes the heading component with the updated label of “Company,” removed the interactive user interface buttons 220a, 220b, and maintained the data table 230. Thus, a user 10 with no coding experience may use the multi-agent code generator 105 to generate the application 126 by simply providing the prompt 102 that includes the natural language text and an image of an example application to be replicated. The prompts 102, however, are not so limited. The prompts 102 may include any software development task that requests to build an application 126 or a portion of an application 126.

Referring back to FIG. 1, in some scenarios, the user 10 provides a query 106 that specifies a particular software development task 104. In particular, the user 10 may be uncertain about the appropriate prompt 102 required to generate software code 124 for the software development task 104. For example, the user 10 may want to add text at the top of an application interface but may not be familiar with the concept of a heading component. Consequently, the user 10 may submit the query 106 of “how do I add text to an application,” to seek guidance. In response, the tool LLM agent 160 processes the query 106 and generates one or more example prompts 162 tailored to the software development task 104 based on the query 106. Continuing with the example above, the tool LLM agent 160 may generate an example prompt 162 of “add a heading component to the application with the following text.”

Additionally, the tool LLM agent 160 may provide information related to what data or information needs to be added to the prompt 102 to generate the desired software code 124. This additional data or information may be included in the example prompt 162. For instance, the tool LLM agent 160 may indicate that the user 10 needs to specify the text content, the font size, the alignment, and the color of the heading component in the prompt 102. Alternatively, the tool LLM agent 160 may provide a template or a placeholder for the data that needs to be added to the prompt 102, such as “add a heading component to the application with the text [text], the font size [size], the alignment [alignment], and the color [color].” The tool LLM agent 160 may also provide feedback or suggestions to the user 10 based on the data entered in the prompt 102, such as validating the syntax, highlighting the errors, or recommending the best practices.

The tool LLM agent 160 sends the one or more example prompts 162 to the user interface 170, which displays the one or more example prompts 162 for the user 10. The user interface 170 may be displayed on a screen of the user device 110. As such, the user 10 may reference the one or more example prompts 162 and provide the prompt 102 specifying the software development task 104. The user interface 170 may also include interactive elements that allow the user 10 to select or modify the example prompts 162 before finalizing the prompt 102. This interactive capability ensures that the user 10 can tailor the prompt 102 to better fit their specific needs and preferences for the software development task 104. Additionally, the user interface 170 may provide real-time feedback or suggestions as the user 10 interacts with the example prompts 162, further enhancing the user experience and ensuring the accuracy of the prompt 102.

In some implementations, the prompt 102 specifying the software development task 104 may necessitate a multi-step approach to generate the software code 124. In some examples, the prompt 102 may specify each step of the multi-step approach. In other examples, the prompt 102 may not specify all or any of the multiple steps required to produce the software code 124. For instance, the prompt 102 may include a snapshot image of an example software application that needs to be replicated. Specifically, the prompt 102 may contain text such as “replicate the software application in this image” along with an image of the example software application.

To create the replicated application 126, the multi-agent code generator 105 may employ multiple operation LLM agents 180, each of which produces a respective portion of software code 124 to accomplish the software development task 104. Continuing with the example, the replicated application 126 based on the image may require several specific steps: adding a heading component to an application page, binding the property “label” to the value “Heading,” adding a list component to the application page, and binding the property “table” to the value “problem” for the list component. In this scenario, multiple operation LLM agents 180 may be necessary to complete the software development task 104.

To that end, the initial LLM 120 may send the query to a planner agent 150. The planner agent 150 is configured to process the query 106 and determine a plan 152 for the query 106. As such, the planner agent 150 may include a multimodal LLM configured to process text, audio, and/or images. The plan 152 includes a sequence of steps 154 needed to accomplish the software development task 104. That is, the plan 152 represents a roadmap that outlines the sequence of steps 154 necessary to achieve the software development task 104. Each step 154 may include a natural language description of the portion of the software development task 104 to be performed. Moreover, the planner agent 150 may determine for each step 154 in the sequence of steps 154 a corresponding class 156. As will become apparent, the class 156 informs the selector agent 185 what the respective step 154 is aiming to accomplish such that the selector agent 185 may select the best suited operation LLM agent 180.

Continuing with the example above the planner agent 150 processes the query 106 to determine the sequence of steps 154 including adding a heading component, binding properties, and adding list components. In some examples, the planner agent 150 sends the plan 152 with the sequence of steps 154 to the user interface 170 such that the sequence of steps 154 is displayed on a screen of the user device 110 for the user 10. Here, the user 10 may observe the sequence of steps 154 and provide a respective prompt 102 corresponding to each step in the sequence of steps 154.

In some implementations, the planner agent 150 sends the plan 152 with the sequence of steps 154 to the selector agent 185. The selector agent 185 is configured to select a respective operation LLM agent 180 from the plurality of operation LLM agents 180 for each step 154 in the sequence of steps 154 based on the corresponding class 156 associated with each step 154. For instance, the first step 154 in the sequence of steps 154 may be associated with the class 156 indicating the heading component such that the selector agent 185 selects the second operation LLM agent 180b conditioned to generate corresponding software code 124 for heading components. Moreover, the third step 154 in the sequence of steps 154 may be associated with the class 156 indicating the list component such that the selector agent 185 selects the third operation LLM agent 180c conditioned to generate corresponding software code 124 for list components. In short, the planner agent 150 may decompose the prompt 102 into the plan 152 including the sequence of steps 154. Thus, users 10 may submit prompts 102 with multiple steps without having the knowledge or needing to split the prompts 102 into prompts.

In some implementations, the multi-agent code generator 105 quantizes each operation LLM agent 180 of the plurality of operation LLM agents 180. The multi-agent code generator 105 may perform by converting each operation LLM agent 180 into smaller, more efficient versions that maintain essential functionalities while reducing computational overhead. By doing so, the multi-agent code generator 105 effectively addresses the computational challenges typically associated with running large LLM models. Moreover, the multi-agent code generator 105 may employ these smaller, quantized operation LLM agents 180 to ensure they can fit into the available Random Access Memory (RAM) and execute within a WebAssembly (WASM) runtime environment to leverage the inherent advantages of WASM, which is natively supported by modern web browsers. As a result, multi-agent code generator 105 mitigates issues related to compute cost and latency, thereby enabling efficient and effective problem-solving directly within the browser environment.

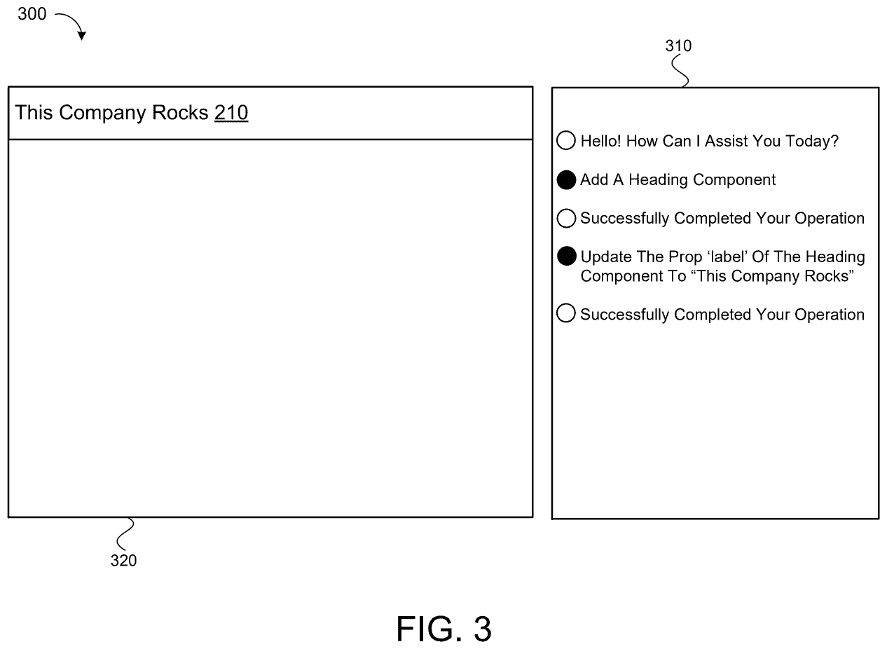

FIG. 3 illustrates an example graphical user interface (GUI) 300 of interacting with the multi-agent code generator 105. The GUI 300 may be displayed on a screen of the user device 110 (FIG. 1). The GUI 300 includes message window 310 displaying messages between the user 10 and the multi-agent code generator 105. In the example shown, messages generated by the multi-agent code generator 105 are next to the white bubbles and messages provided by the user 10 are next to the black bubbles. The message window 310 displays a first message generated by the multi-agent code generator 105 of “Hello! How can I assist you today?” whereby the user 10 responds with the prompt 102 of “Add a heading component.” The multi-agent code generator 150 may process the prompt 102, generate software code 124, and execute the software code 124 to perform the software development task 104 of adding the heading component 210 to the application interface 320 of the GUI 300. Notably, since the first prompt 102 did not specify a value for the heading component, the heading component 210 may include a default value, such as “[HEADING].”

After performing the software development task 104 of adding the heading component 210, the multi-agent code generator 105 may generate the message of “successfully completed your operation” and display the message in the window 310. In response, the user 10 may respond with the prompt 102 of “Update the prop label of the heading component to ‘This Company Rocks.’” The multi-agent code generator 150 may process the prompt 102, generate software code 124, and execute the software code 124 to perform the software development task 104 of adding the label of “This company rocks” to the application interface 320 of the GUI 300. Thus, in the example shown, the multi-agent code generator 105 generates the application 126 to include the application interface 320 with the heading component 210 of “This company rocks” based on the prompts 102 provided by the user 10.

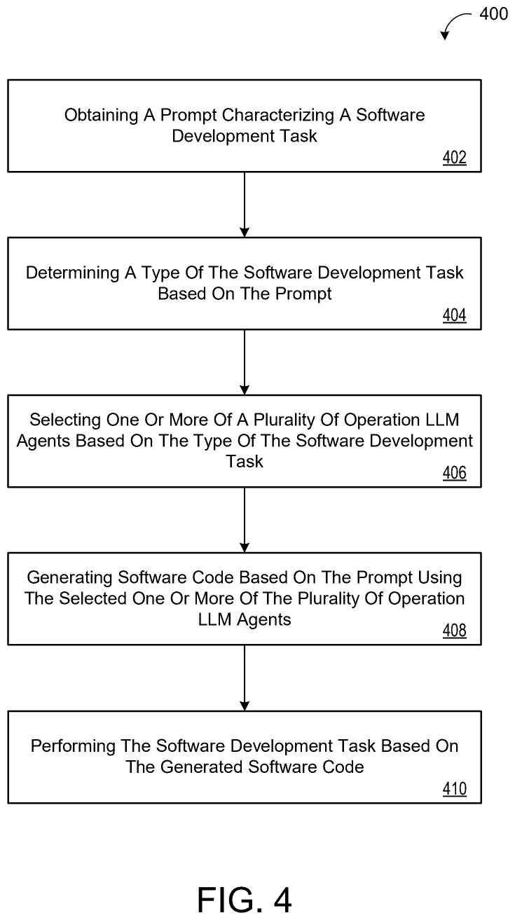

FIG. 4 is a flowchart of an exemplary arrangement of operations for a computer-implemented method 400 for generating software code using the multi-agent code generator 105. At operation 402, the method 400 includes obtaining a prompt 102 characterizing a software development task 104. At operation 404, the method includes determining a type 122 of the software development task 104 based on the prompt 102. At operation 406 the method 400 includes selecting one or more of a plurality of operation LLM agents 180 based on the type 122 of the software development task 104. Each respective operation LLM agent 180 is conditioned to generate corresponding software code 124 for a respective type 122 of software development task 104.

Advantageously, by conditioning each operation LLM agent 180 to generate software code 124 for different types of software development tasks 104, each operation LLM agent 180 is specialized to generate software code 124 in particular scenarios. Using multiple operation LLM agents 180 instead of a single operation LLM agent 180 enables the multi-agent code generator 105 to use longer conditioning prompts 184 to condition the operation LLM agents 180. The longer conditioning prompts 184 enable each operation LLM agent 180 to receive more detailed instructions and guidance on how to specifically perform their designated task. In contrast, a single operation LLM agent 180 would not be able to be conditioned on the conditioning prompts 184 from the plurality of operation LLM agents 180 due to input token limits. At operation 408, the method 400 includes generating, using the selected one or more of the plurality of operation LLM agents 180, software code 124 based on the prompt 102. At operation 410, the method 400 includes performing the software development task 104 based on the generated software code 124.

Additionally, the multi-agent code generator 105 addresses the computational challenges associated with running large LLM models by optionally employing smaller, quantized models that can fit into RAM and execute within, for example, a WebAssembly (WASM) runtime. This approach leverages the native support for WASM in modern browsers, thereby mitigating issues related to compute cost and latency, and enabling efficient problem-solving directly within the browser environment. Moreover, each respective operation LLM agent may be conditioned on a respective conditioning prompt before receiving or processing the prompt. Conditioning the operation LLM agents before receiving the prompt reduces the latency when processing the query to generate software code.

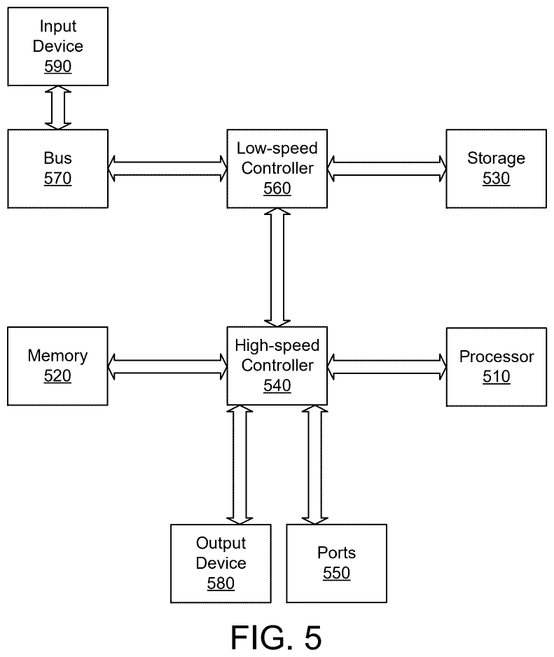

FIG. 5 is a schematic view of an example computing device 500 that may be used to implement the systems and methods described in this document. The computing device 500 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can execute instructions for performing operations within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server cluster, a group of blade servers, or a multi-processor system).

The memory 520 stores information within the computing device 500. The memory 520 may be a non-transitory computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 530 is capable of providing mass storage for the computing device 500. In some implementations, the storage device 530 is a non-transitory computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port or input device 590. The low-speed expansion port 590, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more implementations of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining a prompt characterizing a software development task;
determining, using an initial large language model (LLM) agent, a type of the software development task based on the prompt;
based on the type of the software development task, selecting one or more of a plurality of operation LLM agents, each respective operation LLM agent conditioned to generate corresponding software code for a respective type of software development task;
generating, using the selected one or more of the plurality of operation LLM agents, software code based on the prompt; and
performing the software development task based on the generated software code.

2. The method of claim 1, further comprising, for each respective operation LLM agent:
obtaining a respective conditioning prompt specifying natural language instructions that guide the respective operation LLM agent to generate the corresponding software code for the respective type of the software development task; and
conditioning the respective operation LLM agent on the respective conditioning prompt.

3. The method of claim 2, wherein each respective operation LLM agent is conditioned on the respective conditioning prompt before receiving the prompt.

4. The method of claim 1, wherein each respective operation LLM agent comprises a multimodal LLM configured to process text and image inputs.

5. The method of claim 1, wherein the prompt comprises a natural language command characterizing the software development task.

6. The method of claim 5, wherein the natural language command comprises a textual input or a spoken input.

7. The method of claim 1, wherein the prompt comprises a snapshot image of an example software application to be replicated.

8. The method of claim 7, wherein the snapshot image comprises markup text indicating one or more modifications to perform on the example software application.

9. The method of claim 8, wherein the markup text comprises computer generated text.

10. The method of claim 8, wherein the markup text comprises human written text.

11. The method of claim 1, further comprising quantizing each operation LLM agent of the plurality of operation LLM agents.

12. The method of claim 1, further comprising:
receiving a query specifying the software development task; and
generating, using a tool LLM agent, one or more example prompts for the software development task based on the query.

13. The method of claim 1, wherein each respective operation LLM agent of the plurality of operation LLM agents comprises the same underlying LLM model.

14. The method of claim 1, wherein at least one operation LLM agent of the plurality of operation LLM agents comprises a different underlying LLM model than the other operation LLM agents of the plurality of operation LLM agents.

15. The method of claim 1, wherein performing the software development task comprises building a software application.

16. The method of claim 1, further comprising:
generating, using a first operation LLM agent of the plurality of operation LLM agents, a first portion of the software code based on the prompt; and
generating, using a second operation LLM agent of the plurality of operations LLM agents, a second portion of the software code based on the prompt,
wherein generating the software code is further based on the first portion of the software code and the second portion of the software code.

17. A system comprising:
data processing hardware; and
memory hardware in communication with the data processing hardware, the memory hardware storing instructions that when executed on the data processing hardware cause the data processing hardware to perform operations comprising:
obtaining a prompt characterizing a software development task;
determining, using an initial large language model (LLM) agent, a type of the software development task based on the prompt;
based on the type of the software development task, selecting one or more of a plurality of operation LLM agents, each respective operation LLM agent conditioned to generate corresponding software code for a respective type of software development task;
generating, using the selected one or more of the plurality of operation LLM agents, software code based on the prompt; and
performing the software development task based on the generated software code.

18. The system of claim 17, wherein the operations further comprise, for each respective operation LLM agent:
obtaining a respective conditioning prompt specifying natural language instructions that guide the respective operation LLM agent to generate the corresponding software code for the respective type of the software development task; and
conditioning the respective operation LLM agent on the respective conditioning prompt.

19. The system of claim 18, wherein the operations further comprise:
generating, using a first operation LLM agent of the plurality of operation LLM agents, a first portion of the software code based on the prompt; and
generating, using a second operation LLM agent of the plurality of operations LLM agents, a second portion of the software code based on the prompt,
wherein generating the software code is further based on the first portion of the software code and the second portion of the software code.

20. A computer-readable medium having instructions that, when executed by data processing hardware, causes the data processing hardware to perform operations comprising:
obtaining a prompt characterizing a software development task;
determining, using an initial large language model (LLM) agent, a type of the software development task based on the prompt;
based on the type of the software development task, selecting one or more of a plurality of operation LLM agents, each respective operation LLM agent conditioned to generate corresponding software code for a respective type of software development task;
generating, using the selected one or more of the plurality of operation LLM agents, software code based on the prompt; and
performing the software development task based on the generated software code.
